(19) United States
(12) Patent Application Publication
(10) Pub. No.: US 2020/0081671 A1
(43) Pub. Date: Mar. 12, 2020

(54) IMAGE FORMING DEVICE, IMAGE FORMING SYSTEM AND DESTINATION SETTING METHOD

(71) Applicant: Konica Minolta, Inc., Tokyo (JP)

(72) Inventor: Akito Ota, Toyohashi-shi (JP)

(73) Assignee: Konica Minolta, Inc., Tokyo (JP)

(21) Appl. No.: 16/565,833

(22) Filed: Sep. 10, 2019

(30) Foreign Application Priority Data
Sep. 11, 2018 (JP) 2018-169318

(51) Int. Cl. G06F 3/12

(52) U.S. Cl. CPC G06F 3/1254; G06F 3/1208; G06F 3/1256

(57) ABSTRACT

An image forming device, including: an image former that forms an image on a sheet; an image reader that reads an image of a document; and a hardware processor that sends an email with attached document data that is obtained using the image reader, that causes a display to display a seat table in which a seat position of a person is associated with an email address of the person, and that sets, as a destination of the email, an email address of a person that corresponds to a seat that is selected by a user from the seat table.

### CROSS-REFERENCE TO RELATED APPLICATIONS

This application claims priority from Japanese Patent Application No. 2018-169318 filed on Sep. 11, 2018, the entire contents of which are incorporated herein by reference.

### TECHNICAL FIELD

The present invention relates to an image forming device, an image forming system and a destination setting method.

### BACKGROUND

MFP (Multi-Function Peripherals), which is a multi-functional digital image forming device including a plurality of functions such as a printer function, a copy function, a facsimile function and a scanner function, has been conventionally known. As for the above MFP, there is a request for sending, to a predetermined person, document data obtained by scanning.

Thus, a configuration of extracting destination information from document data obtained by scanning a printed matter and displaying a screen for identifying the person of the destination by referring to the extracted destination information is disclosed (for example, see JP 2008-219667A). In this case, the person in charge of distributing the printed matter refers to the displayed screen and distributes the printed matter to the predetermined person.

However, though the technique described in JP 2008-219667A specifies a person of the destination to send the printed matter and displays the person in the displayed seat table, the technique cannot automatically send the document data obtained by the scanning to the person of the destination. Accordingly, the person in charge of distributing the printed matter needs to deliver the printed matter all the way to the person of the destination, which is troublesome and may cause error of the destination.

There is known a function (hereinafter, ScanToEmail) of sending the document data obtained by scanning to a specified email address.

Conventionally, in a case of specifying the destination (email address) by ScanToEmail, the destination selected from a destination list is set. In this case, the name of the addressee needs to be searched for and selected from destinations that are used regularly or the initial letters thereof, which is troublesome. In a case where users having same family names or same first and last names are registered in the destination list, a correct destination cannot be selected unless the email address of the addressee is accurately remembered.

### SUMMARY

One or more embodiments of the prevent invention provide an image forming device, an image forming system and a destination setting method which enable easy and accurate specification of the destination without remembering of the email address or the full name of the addressee.

An image forming device according to one or more embodiments of the present invention includes: an image former that forms an image on a sheet; a hardware processor; an image reader that reads an image of a document; and an email sender that sends an email with attached document data that is obtained by the image reader reading the image of the document, wherein the hardware processor causes a display to display a seat table in which a seat position of a person and an email address of the person are associated with each other, and the hardware processor sets, as a destination to send the email by the email sender, an email address of a person corresponding to a seat that is selected by a user from the seat table displayed on the display.

An image forming system according to one or more embodiments of the present invention includes: an image forming device including an image former that forms an image on a sheet and a hardware processor; and an information processing device that is connected to the image forming device to be able to communicate data, wherein the information processing device includes: a storage that stores a seat table in which a seat position of a person and an email address of the person are associated with each other; and a hardware processor that sends the seat table stored in the storage to the image forming device, the image forming device includes: an image reader that reads an image of a document; and an email sender that sends an email with attached document data that is obtained by the image reader reading the image of the document, the hardware processor of the image forming device causes a display to display the seat table that is sent by the hardware processor of the information processing device, and

the hardware processor of the image forming device sets, as a destination to send the email by the email sender, an email address of a person corresponding to a seat that is selected by a user from the seat table displayed on the display.

A destination setting method of an image forming device according to one or more embodiments of the present invention is a destination setting method of an image forming device including an image former that forms an image on a sheet, the method including: display controlling that is causing a display to display a seat table in which a seat position of a person and an email address of the person are associated with each other; and destination setting that is setting, as a destination to send an email by an email sender, an email address of a person corresponding to a seat selected by a user from the seat table that is displayed on the display in the display controlling, the email sender sending the email with attached document data obtained by an image reader reading an image of a document.

### BRIEF DESCRIPTION OF THE DRAWINGS

The advantages and features provided by embodiments of the invention will become more fully understood from the detailed description given hereinafter and the appended drawings which are given by way of illustration only, and thus are not intended as a definition of the limits of the present invention, and wherein:

FIG. 1 is a view showing a configuration of an image forming system according to one or more embodiments;

FIG. 2 is a front view showing a schematic configuration of an image forming device;

FIG. 3 is a functional block diagram showing a control configuration of the image forming device;

FIG. 4 is a view showing an example of data configuration of a seat table (seat table);

FIG. 5 is a flowchart showing an example of an operation of the image forming device;

FIG. 6 is a view showing an example of a registered destination list screen;

FIG. 7 is a view showing an example of a seat table screen;

FIG. 8 is a view showing an example of how a seat is selected in the seat table screen;

FIG. 9 is a view showing an example of an address display screen;

FIG. 10 is a view showing an example of how a plurality of seats are selected in the seat table screen;

FIG. 11 is a view showing an example of an address display screen in a case where a plurality of seats is selected;

FIG. 12 is a view showing an example of how seats are selected at once (i.e., selected at the same time) by a block unit;

FIG. 13 is a view showing an example of how seats in a region specified by a user are selected at once;

FIG. 14 is a view showing an example of how seats are selected at once by a group unit;

FIG. 15 is a view showing an example of how a seat table screen of aa building 2F is displayed;

FIG. 16 is a view showing an example of how “iijk” is selected in the registered destination list screen;

FIG. 17 is a view showing an example of how the seat of a selected person is displayed to be emphasized;

FIG. 18 is a view showing an example of how the seat table is displayed to be scrollable;

FIG. 19 is a view showing an example of how an area including the seat of the user is initially displayed;

FIG. 20 is a view showing an example of how the name of a person corresponding to each seat is displayed;

FIG. 21 is a view showing an example of how personal information of the person of the selected seat is displayed;

FIG. 22 is a view showing a configuration of an image forming system according to a modification example 14; and

FIG. 23 is a flowchart showing an example of an operation of the image forming system according to the modification example 14.

### DETAILED DESCRIPTION

Hereinafter, embodiments of the present invention will be described in detail with reference to the drawings. However, the scope of the invention is not limited to the disclosed embodiments.

[1. Configuration]

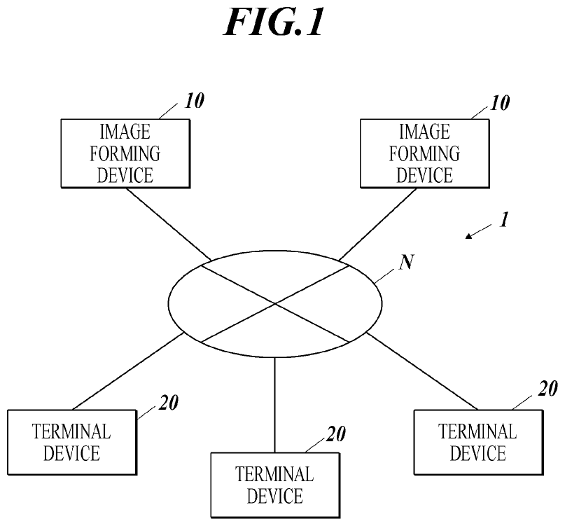

As shown in FIG. 1, an image forming system 1 according to one or more embodiments is configured by including an image forming device 10 and a terminal device 20 which receives an email sent from the image forming device 10. Each of the devices forming the image forming system 1 is connected to a communication network N so as to be able to perform data communication. In detail, the communication network N is LAN (Local Area Network) to which various communication lines such as a telephone line, a leased line, a mobile communication network, a communication satellite network, and a CATV line can be applied. Various network forms such as WAN (Wide Area Network) and Internet may be applied.

The image forming device 10 according to one or more embodiments is an MFP including a plurality of functions such as a printer function, a copy function, a facsimile function and a scanner function. The image forming device 10 forms an image on a sheet on the basis of image data obtained by reading an image from a document or image data (print data) received from an external device such as the terminal device 20.

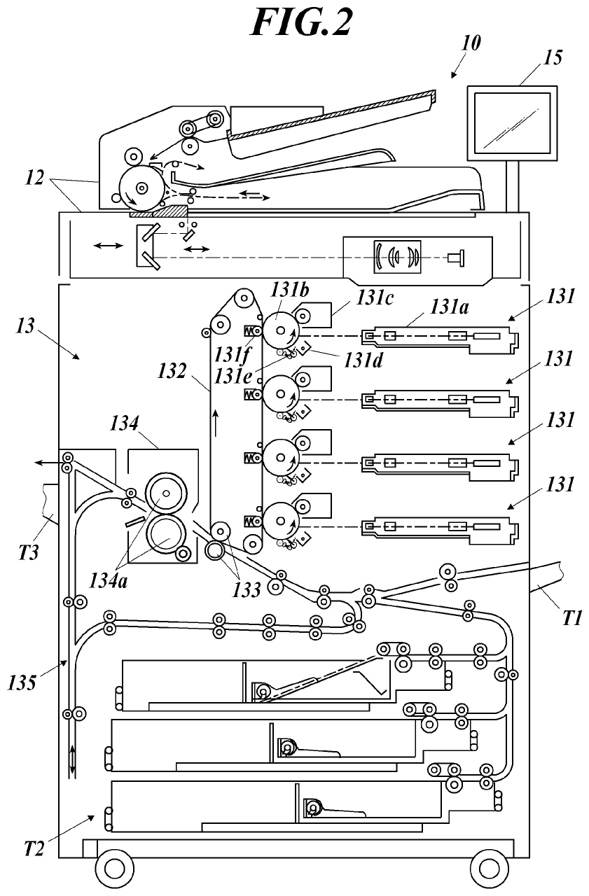

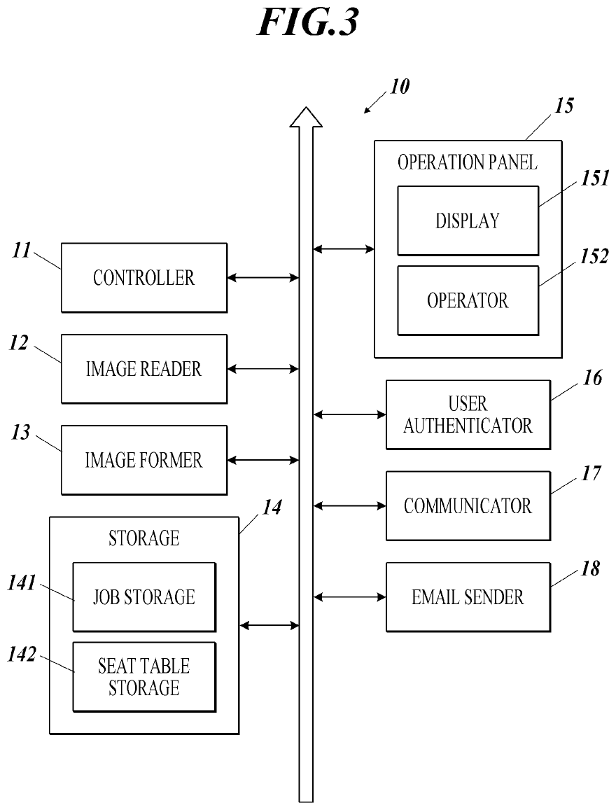

As shown in FIGS. 2 and 3, the image forming device 10 is configured by including a controller 11 (hardware processor), an image reader 12, an image former 13, a storage 14, an operation panel 15 (display 151, operator 152), a user authenticator 16, a communicator 17 and an email sender 18.

The controller 11 is configured by including a CPU, a RAM, a ROM and the like. In accordance with the operation signal input from the operator 152 or the instruction signal received by the communicator 17, the CPU reads out various processing programs stored in the ROM, and loads them to the RAM, and integrally controls the operation of the image forming device 10 in cooperation with the various programs loaded to the RAM.

For example, the controller 11 achieves the function (ScanToEmail) of sending the document data obtained by scanning the document with the image reader 12 to a specified email address via the email sender 18. In detail, the controller 11 causes the display 151 to display seat table data stored in the storage 14, sets the email address of a person corresponding to a seat selected by the user as the destination of ScanToEmail, and causes the document data obtained by the scanning to be sent via email.

The image reader 12 performs scanning and exposure to the image of the document placed on a document table or ADF (Auto Document Feeder) not shown in the drawings by the optical system of the scanning exposure device, reads the reflected light with a line image sensor, and thus obtains the image signal. After processing such as A/D conversion, shading correction and compression is performed to the image signal, the processed image signal is input as image data to the controller 11. The image data input to the controller 11 is not limited to the data read by the image reader 12, and for example, may be received from the terminal device 20 via the communicator 17.

The image former 13 forms an image formed of four colors of C, M, Y and K on a sheet according to pixel values of four colors of respective pixels of the original image to which image processing was performed.

As shown in FIG. 2, the image former 13 is configured by including four writing units 131, an intermediate transfer belt 132, secondary transfer rollers 133, a fixer 134 and the like.

The four writing units 131 are arranged in series (tandem) along the belt surface of the intermediate transfer belt 132, and form images of respective colors of C, M, Y and K. Each of the writing units 131 has a same configuration except for that the color of the formed image is different. Each of the writing units 131 is configured by including a light exposer 131a, a photoreceptor 131b, a developer 131c, a charger 131d, a cleaner 131e and a primary transfer roller 131f as shown in FIG. 2.

At the time of image formation, each of the writing units 131 charges the photoreceptor 131b by the charger 131d, thereafter scans the photoreceptor 131b with light beams emitted by the light exposer 131a on the basis of the original image, and forms an electrostatic latent image. When developing is performed by supplying color materials such as toners with the developer 131c, an image is formed on the photoreceptor 131b.

The images formed on the respective photoreceptors 131b of the four writing units 131 are transferred (primarily transferred) in order to be laid on each other on the intermediate transfer belt 132 by the respective primary transfer rollers 131f. Thus, the images of respective colors are formed on the intermediate transfer belt 132. The intermediate transfer belt 132 is an image carrier which rotates by being wounded on a plurality of rollers and rotated. After primary transferring, the color materials remaining on the photoreceptors 131b are removed by the respective cleaners 131e.

The image former 13 feeds a sheet from a manual tray T1 or a sheet feeding tray T2 at the timing when the image on the rotating intermediate transfer belt 132 reaches the position of the secondary transfer roller 133. In the secondary transfer roller 133, one of a pair of rollers presses against the intermediate transfer belt 132, and the other is formed as one of the plurality of rollers rotating the intermediate transfer belt 132. When the image is transferred (secondarily transferred) onto the sheet from the intermediate transfer belt 132 by pressing of the secondary transfer roller 133, the sheet is conveyed to the fixer 134 to perform fixing processing, and ejected to the sheet ejection tray T3. The fixing processing is processing of fixing the image onto the sheet by heating and pressurizing the sheet with fixing rollers 134a. In a case where the image is formed on both sides of the sheet, after the sheet is conveyed to a reversing path 135 and reversed, the sheet is fed to the position of the secondary transfer roller 133 again.

The storage 14 is a nonvolatile storage formed of an HDD (Hard Disk Drive), an SSD (Solid State Drive) or the like, and stores various types of programs, various types of setting data and the like so as to be readable and writable from the controller 11.

The storage 14 is configured by including a job storage 141 which can store various jobs. For example, when the controller 11 obtains a print job sent from the terminal device 20 via the communicator 17, the controller 11 stores the print job in the job storage 141.

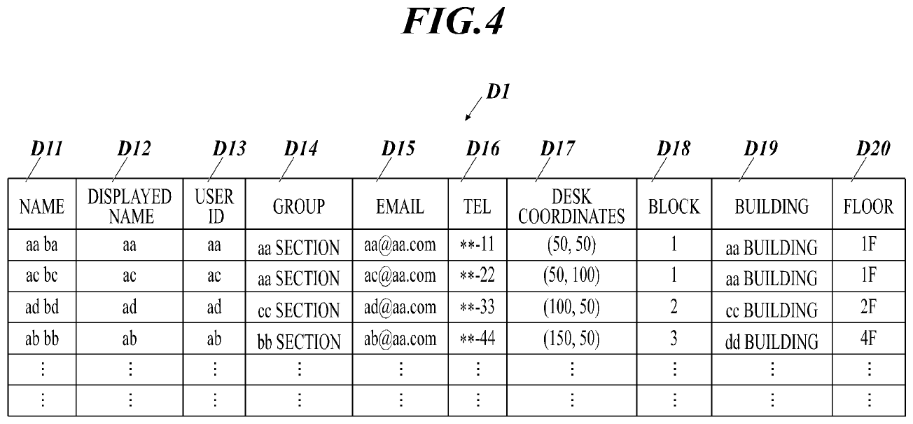

The storage 14 also includes a seat table storage 142 which can store data of a seat table in which the seat position of each person is associated with the email address of the person. FIG. 4 shows an example of data configuration of the seat table (seat table D1).

As shown in FIG. 4, the seat table D1 records information such as “name D11” which is name information of a person, “displayed name D12” which is information described in a desk (seat) displayed on the display 151, “user ID D13” which is used when the person logs in to the image forming device 10 and the terminal device 20, “group D14” regarding a section to which the person belongs, “E-mail D15” which is the email address of the person, “TEL D16” which is a phone number of the person, “desk coordinates D17” which is coordinate information (X coordinate, Y coordinate) for drawing the seat on the display 151, “block D18” indicating the block (island) to which the seat belongs, “building D19” indicating the building in which the seat is located and “floor D20” indicating the floor in each building where the seat is located, so as to be associated with each other.

The operation panel 15 is configured by including a display 151 which displays various type of information to the user and an operator 152 which receives the operation input by the user.

The display 151 is configured by including a color liquid crystal display or the like, and displays an operation screen or the like (various types of setting screens, various types of buttons, operation status of each function and the like) in accordance with the display control signal input from the controller 11. For example, the display 151 displays the data of the seat table.

The operator 152 is configured by including a touch panel which is provided on the screen of the display 151, and various hard keys which are arranged around the screen of the display 151. When a button displayed on the screen is pressed by a finger, a touch pen or the like, the operator 152 detects the X and Y coordinates of the pressed point by the voltage value, and outputs the operation signal corresponding to the detected position to the controller 11. The touch panel is not limited to the pressure sensitive type, and may be static type and optical type, for example. When a hard key is pressed, the operator 152 outputs the operation signal corresponding to the pressed key to the controller 11. The user can perform setting regarding image formation such as image quality setting, magnification setting, application setting, output setting and paper setting, sheet conveyance instruction and stop operation of device, by operating the operator 152.

The user authenticator 16 performs authentication processing for identifying the user by comparing the authentication data such as the ID and the password input by the user with reference data which was registered in advance. The reference data may be stored in the storage 14, or may be stored in an external server device or the like not shown in the drawings. The user authentication may be performed by the external server device and the user authenticator 16 may identify the user on the basis of the result of the user authentication.

The communicator 17 is an interface which connects the image forming device 10 with the communication network N. The communicator 17 has a communication IC, a communication connector and the like, and performs sending and reception of various types of information with another image forming device 10 or the terminal device 20 which is connected to the communication network N by using a predetermined communication protocol under the control by the controller 11. The communicator 17 can input and output various types of information via the USB.

The email sender 18 sends the email with the attached document data, which is obtained by the scanning with the image reader 12, to the email address specified by the user via the operator 152.

[2. Operation]

Next, the operation of the image forming device 10 in the image forming system 1 according to one or more embodiments will be described with reference to the flowchart in FIG. 5. The operation is started in response to a trigger that the controller 11 detects the pressing of a scan button (hard key provided on the operator 152 or soft key displayed on the display 151) by the user.

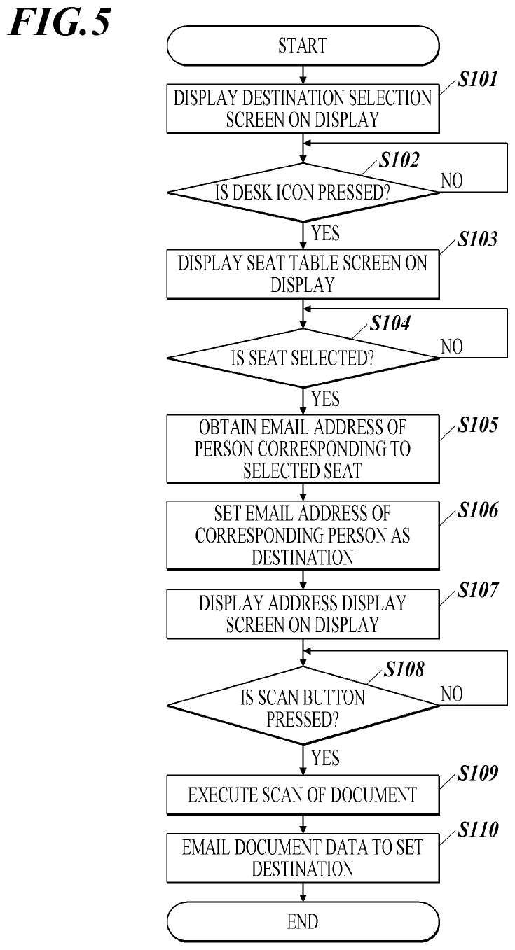

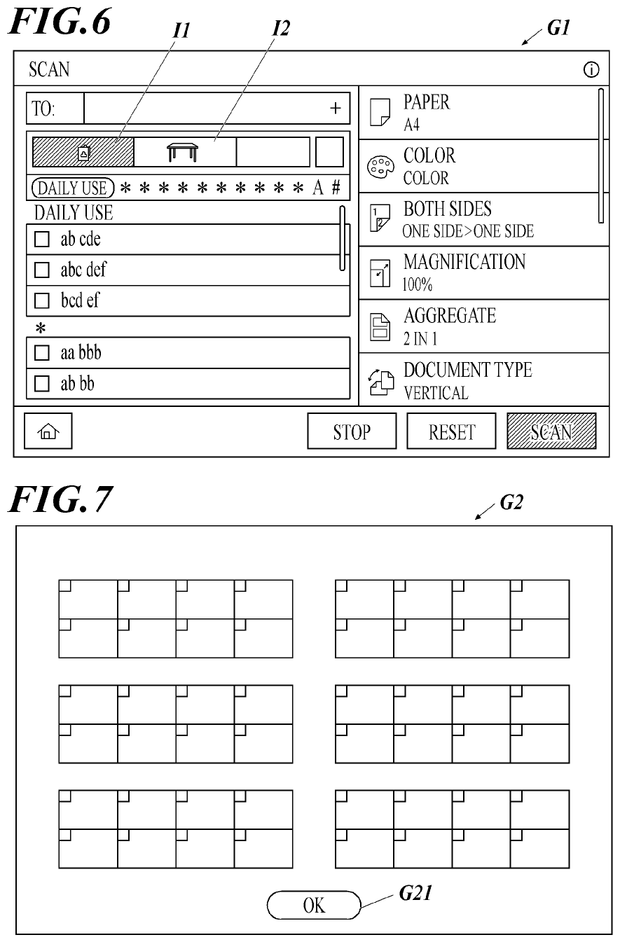

The controller 11 first causes the display 151 to display a registered destination list screen G1 (see FIG. 6) displaying a list of the destinations of ScanToEmail which were registered in advance (step S101). As shown in FIG. 6, the registered destination list screen G1 is provided with a list icon I1 to display a list of the destinations of ScanToEmail and a desk icon I2 to shift to the seat table screen. In the registered destination list screen G1, the information of “name D11” in the seat table D1 (see FIG. 4) is displayed as a list, and the email address of the person selected by the user is obtained from “E-mail D15” in the seat table D1.

Next, the controller 11 determines whether the desk icon I2 provided in the registered destination list screen G1 displayed in step S101 is pressed (step S102). The operation to press the desk icon I2 corresponds to “predetermined user operation” of one or more embodiments of the present invention.

If the controller 11 determines that the desk icon I2 which is provided in the registered destination list screen G1 displayed in step S101 is pressed (step S102; YES), the controller 11 proceeds to the next step S103.

On the other hand, if the controller 11 determines that the desk icon I2 provided in the registered destination list screen G1 displayed in step S101 is not pressed (step S102; NO), the controller 11 repeats the processing of step S102 until the desk icon I2 is pressed.

Next, the controller 11 causes the display 151 to display the seat table screen G2 (see FIG. 7) (step S103). As shown in FIG. 7, the seat table screen G2 is provided with an OK button G21 to complete the selection of seat. In the seat table screen G2, the seat positions of persons and the email addresses of the respective persons are associated with each other. That is, the controller 11 functions as a display controller of one or more embodiments of the present invention. Each of the seats displayed in the seat table screen G2 is drawn on the basis of “desk coordinates D17” in the seat table D1 (see FIG. 4).

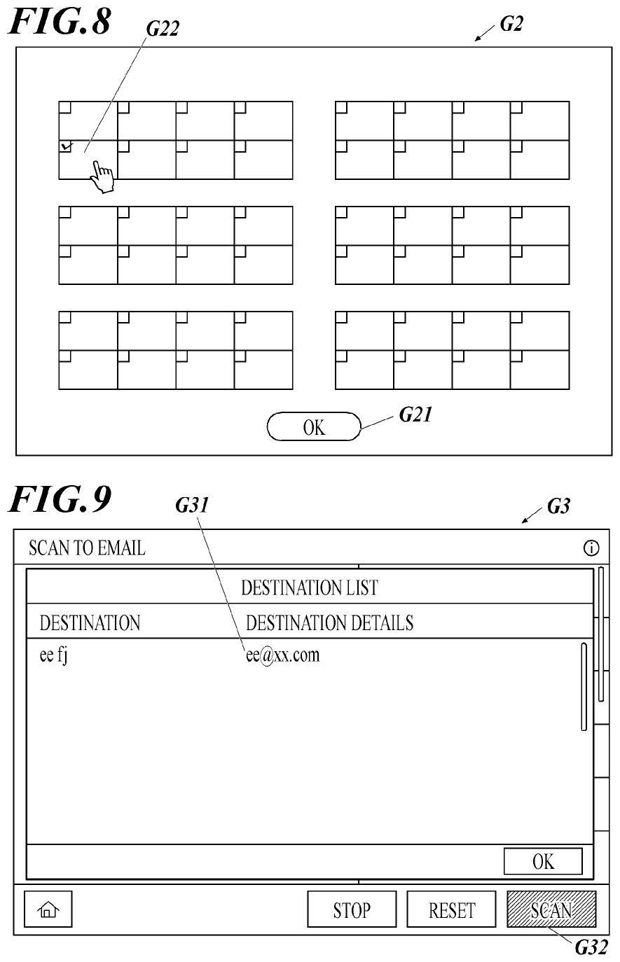

Next, the controller 11 determines whether a seat was selected in the seat table screen G2 displayed in step S103 (step S104). In detail, the controller 11 determines that the seat was selected when the OK button G21 provided in the seat table screen G2 is pressed after the seat was selected in the seat table screen G2. FIG. 8 shows an example of how the seat is selected in the seat table screen G2. In one or more embodiments, a check mark is provided to the selected seat G22.

If the controller 11 determines that the seat was selected (step S104; YES), the controller 11 proceeds to the next step S105.

On the other hand, if the controller 11 determines that the seat is not selected (step S104; NO), the controller 11 repeats the processing of step S104 until the seat is selected.

The controller 11 obtains the email address of the person corresponding to the selected seat (step S105). The email address of the person corresponding to the selected seat is obtained on the basis of “E-mail D15” in the seat table D1 (see FIG. 4).

The controller 11 sets the email address obtained in step 105 as the destination of ScanToEmail (sets as the destination to send the email by the email sender 18) (step S106). That is, the controller 11 functions as the destination setter of one or more embodiments of the present invention.

The controller 11 causes the display 151 to display the address display screen G3 (see FIG. 9) displaying the email address G31 which was set as the destination of ScanToEmail in step S106 (step S107). As shown in FIG. 9, the address display screen G3 is provided with a scan button G32 for executing scanning of the document by the image reader 12.

The controller 11 determines whether the scan button G32 provided in the address display screen G3 displayed in step S107 was pressed (step S108).

If the controller 11 determines that the scan button G32 provided in the address display screen G3 displayed in step S107 was pressed (step S108; YES), the controller 11 proceeds to the next step S109.

On the other hand, if the controller 11 determines that the scan button G32 provided in the address display screen G3 displayed in step S107 was not pressed (step S108; NO), the controller 11 repeats the processing of step S108 until the scan button G32 is pressed.

The controller 11 executes scanning of the document by the image reader 12 (step S109).

The controller 11 sends via email the document data obtained by the scanning in step S109 to the destination which was set in step S106 via the email sender 18 (step S110).

As described above, the image forming device 10 in the image forming system 1 according to one or more embodiments includes an image reader 12 which reads the image of the document, an email sender 18 which sends the email with attached document data that was obtained by the image reader 12 reading the image of the document, a display controller (controller 11) which causes a display 151 to display a seat table in which the seat position of each person and the email address of the person are associated with each other, and a destination setter (controller 11) which sets the email address of the person corresponding to the seat which was selected by the user from the seat table displayed on the display 151 by the display controller, as the destination to send the email by the email sender 18.

Therefore, according to the image forming device 10 in one or more embodiments, the destination to send the email can be specified by seeing the seat table displayed on the display 151. Thus, it is not necessary to remember the email address or full name of the addressee, and the destination can be specified easily and accurately.

According to the image forming device 10 in one or more embodiments, the display controller further causes the display 151 to display the registered destination list screen displaying a list of the destinations which were registered in advance, and causes the display 151 to display the seat table on the basis of a predetermined user operation in the registered destination list screen.

Therefore, according to the image forming device 10 in one or more embodiments, in a case where it is difficult to select the destination from the list of the destinations, the seat table can be displayed by an easy operation. Thus, it is possible to specify the destination simply and accurately.

According to the image forming device 10 in one or more embodiments, a storage 14 which stores the seat table is provided.

Therefore, according to the image forming device 10 in one or more embodiments, the seat table can be displayed without providing an external server device or the like. Thus, it is possible to reduce the operation cost.

Although embodiments of the present invention have been described in detail, the present invention is not limited to the above embodiments, and changes can be made within the scope of the present invention.

### Modification Example 1

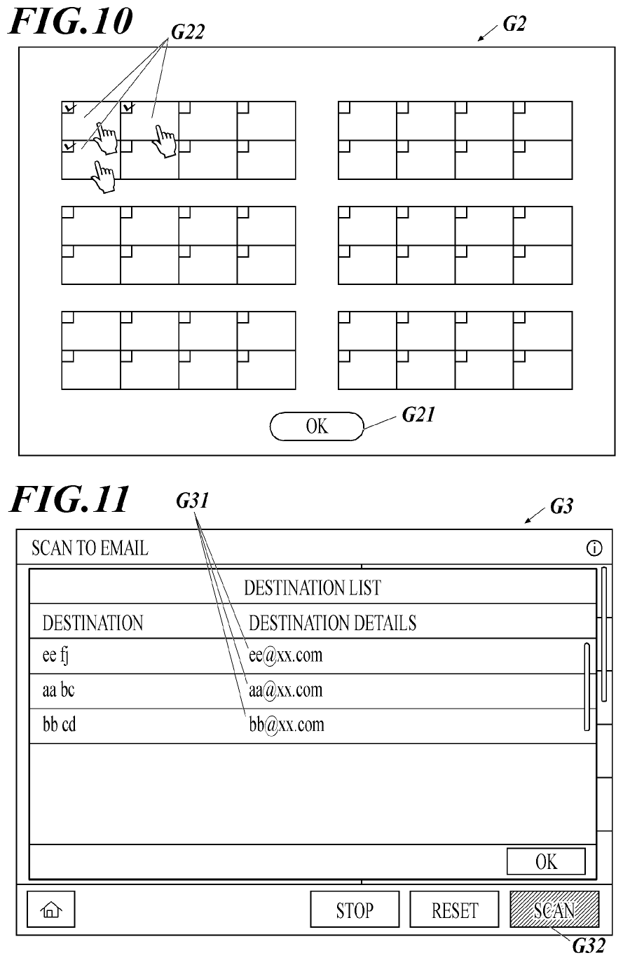

For example, though one or more embodiments has been described by illustrating a case where a single email address is set as the destination of ScanToEmail (case where a single seat is selected in the seat table screen G2), the present invention is not limited to this. For example, a plurality of email addresses may be set as destinations of ScanToEmail (a plurality of seats may be selected in the seat table screen G2). FIG. 10 shows an example of how a plurality of (three in the drawing) seats are selected in the seat table screen G2. FIG. 11 shows an example of the address display screen G3 in a case where a plurality of (three in the drawing) seats are selected.

As described above, a plurality of destinations can be specified easily by the destination setter setting the email addresses of persons respectively corresponding to the plurality of seats which were selected by the user, as destinations to send the email by the email sender 18. Thus, it is possible to reduce the trouble for specifying the destinations.

### Modification Example 2

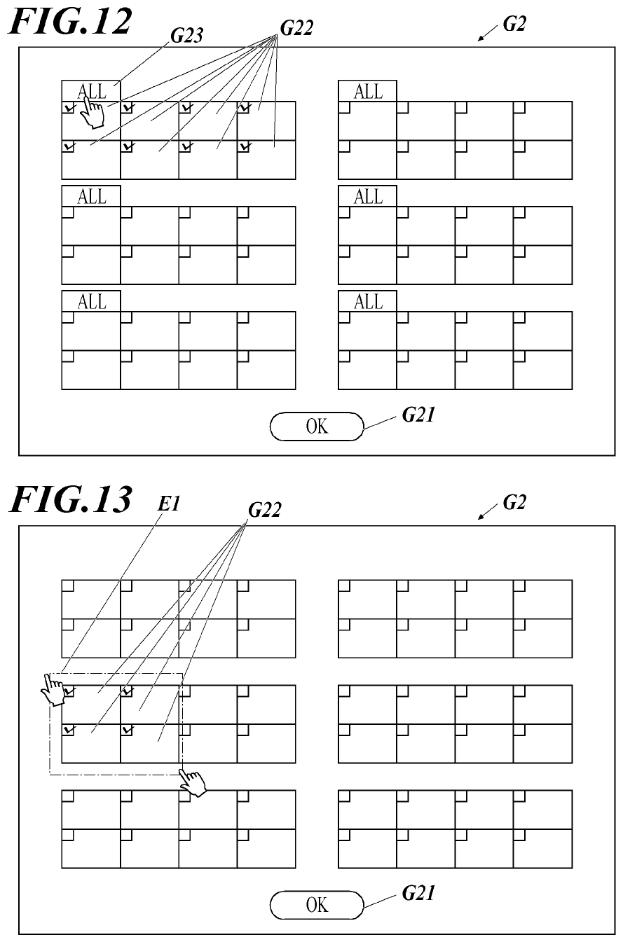

A plurality of email addresses which were selected at once (i.e., selected at the same time) by the block (island) unit may be set (the seats may be selected at once by the block unit in the seat table screen G2) as the destinations of ScanToEmail. FIG. 12 shows an example of how seats are selected at once by the block unit in the seat table screen G2. As shown in FIG. 12, ALL button G23 for selecting all seats at once by the block unit is provided to each block in the seat table screen G2 in the modification example 2. When ALL button G23 is touched by the user, the seats belonging to the block corresponding to the touched ALL button G23 are selected at once. Each ALL button G23 is associated with “block D18” in the seat table D1 (see FIG. 4). When ALL button G23 for which “block D18” is 1 is touched, for example, the person for which the information of “block D18” is 1 is selected.

As described above, the destinations can be specified by the block unit simply by the destination setter setting email addresses of the respective persons corresponding to the plurality of seats which were selected at once by the block unit by the user, as the destinations to send the email by the email sender 18. Thus, it is possible to reduce the trouble for specifying the destinations.

### Modification Example 3

It is possible to set email addresses of respective persons corresponding to a plurality of seats in a region specified by the user as the destinations of ScanToEmail (it is possible to select at once the seats in the region which was specified by the user in the seat table screen G2). FIG. 13 shows an example of selecting at once the seats in the region E1 which was specified by the user in the seat table screen G2. Whether a seat is located in the region E1 specified by the user is determined by whether the coordinates of “desk coordinates D17” in the seat table D1 (see FIG. 4) are located in the range of the region E1.

As described above, a plurality of destinations can be specified simply by the destination setter setting the email addresses of respective persons corresponding to the plurality of seats in the region which was specified by the user, as the destinations to send the email by the email sender 18. Thus, it is possible to reduce the trouble for specifying the destinations.

### Modification Example 4

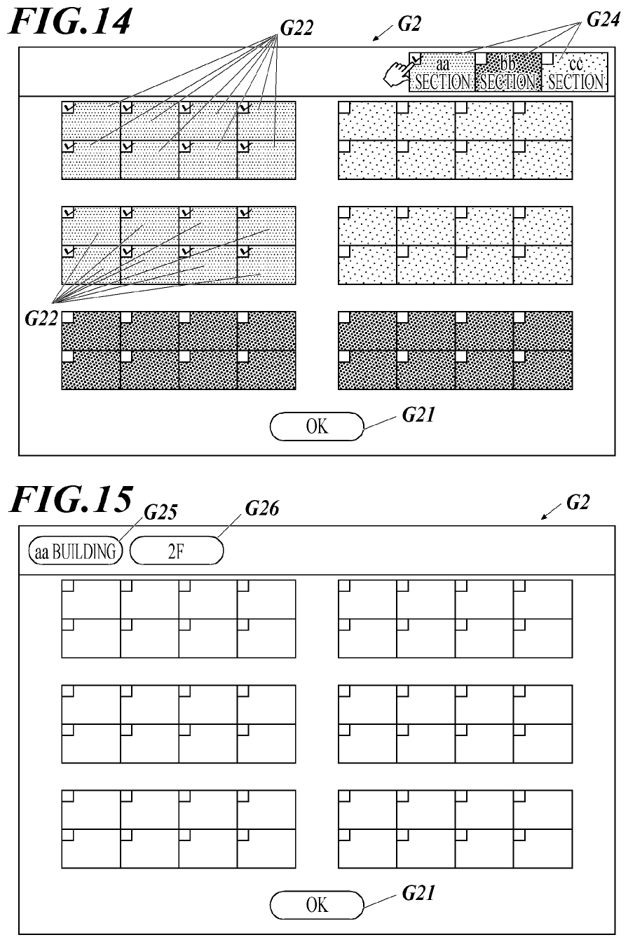

It is possible to set a plurality of email addresses which were selected at once by the group (section or the like) unit to which the persons belong, as the destinations of ScanToEmail (it is possible to select at once the seats by the group unit in the seat table screen G2). FIG. 14 shows an example of selecting at once the seats by the group unit in the seat table screen G2. In the example shown in FIG. 14, the seat position of each person and the group to which the person belongs are associated with each other, and each seat is grouped according to the section. Group buttons G24 for selecting seats by the group unit at once are provided for respective groups in the upper section of the seat table screen G2 in the modification example 4 as shown in FIG. 14. When a group button G24 is touched by the user, the seats of persons who belong to the group are selected at once. Each group button G24 is associated with “group D14” in the seat table D1 (see FIG. 4). When the group button G24 for which “group D14” is “aa section” is touched, for example, the person for which the information of “group D14” is “aa section” is selected.

As described above, destinations can be specified simply by the group unit, by the display controller further causing the display 151 to display the seat table associating the seat position of each person with the group to which the person belongs and by the destination setter setting the email addresses of respective persons corresponding to the plurality of seats which were selected at once by the group unit by the user, as the destinations to send the email by the email sender 18. Thus, it is possible to reduce the trouble for specifying the destinations.

### Modification Example 5

Though the single seat table is displayed by the display 151 in one or more embodiments, the present invention is not limited to this. For example, data of a plurality of seat tables (for example, data of seat table for each building and floor) may be stored in the storage 14 and the plurality of seat tables may be displayed on the display 151 selectively. FIG. 15 shows an example of displaying the seat table screen G2 of aa building 2F. As shown in FIG. 15, a building selection button G25 for selecting the building for which the seat table is displayed and a floor selection button G26 for selecting the floor for which the seat table is displayed are provided to the seat table screen G2 in the modification example 5. When the user touches the building selection button G25, a list of buildings is displayed as a drop-down list. When the user selects a single building (for example, aa building), the selected building (for example, aa building) is set as the building for which the seat table is displayed. Similarly, when the user touches the floor selection button G26, a list of floors is displayed as a drop-down list. When the user selects a single floor (for example, 2F), the selected floor (for example, 2F) is set as the floor for which the seat table is displayed. When the building and the floor for which the seat table is displayed are set, the seat table of the building and the floor which were set is displayed on the display 151. The seat table data is associated with “building D19” and “floor D20” in the seat table D1 (see FIG. 4). The seat information of the person who belongs to the “building D19” and “floor D20” which were selected by the user is drawn on the display 151.

As described above, the seat of the addressee can be found easily by the display controller displaying the seat table on the display 151 for each building and floor. Thus, it is possible to reduce the trouble for specifying the destination.

### Modification Example 6

In a case where a plurality of seat tables is displayed on the display 151 selectively, the seat table of the building and the floor where the device (image forming device 10) is provided may be initially displayed. For example, in a case where the device is set on 2F of aa building, the seat table screen G2 of aa building 2F (see FIG. 15) may be initially displayed.

As described above, the seat table of the floor where the device is set and thus the email is most assumed to need to be sent is initially displayed by the display controller causing the display 151 to initially display the seat table of the building and the floor where the image forming device 10 is set. Thus, it is possible to improve the operation efficiency of the image forming device 10 for specifying the destination.

### Modification Example 7

In a case where a plurality of seat tables is displayed on the display 151 selectively, the seat table including the seat of the user may be initially displayed. The user here indicates the user who has logged in to the image forming device 10 and is using the image forming device 10. For example, in a case where the user has the seat on 2F of aa building, the seat table screen G2 of aa building 2F (see FIG. 15) may be initially displayed. The authentication information of the user (“user ID D13” in the seat table D1 (see FIG. 4)) and the seat table data are connected to each other, and the seat table which is connected to “user ID D13” of the user is initially displayed on the display 151.

As described above, the seat table including seats around the seat of the user, to which the email is most likely to be sent, is initially displayed by the display controller causing the display 151 to initially display the seat table including the seat of the user. Thus, it is possible to improve the operation efficiency of the image forming device 10 for specifying the destinations.

### Modification Example 8

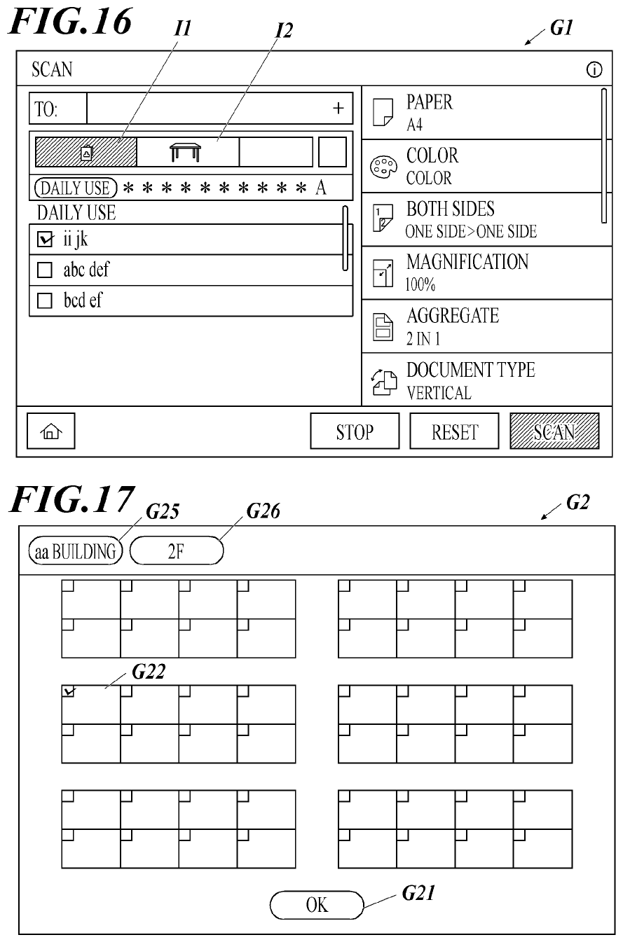

In a case where a plurality of seat tables is displayed on the display 151 selectively, the seat table including a person who was selected in the registered destination list screen G1 (see FIG. 16, for example) may be initially displayed. For example, as shown in FIG. 16, in a case where the desk icon I2 is pressed in a state in which “iijk” who is a user in “aa building 2F” is selected from the list of the destinations displayed as a list in the registered destination list screen G1, the seat table screen G2 of aa building 2F (see FIG. 15) may be initially displayed.

As described above, whether the destination to send the email is correct or not can be finally confirmed by the display controller causing the display 151 to initially display the seat table including the person who was selected in the registered destination list screen displaying a list of the destinations which were registered in advance. Thus, it is possible to specify the destination accurately.

### Modification Example 9

When the seat table including a person who was selected in the registered destination list screen G1 (see FIG. 16, for example) is initially displayed, the seat of the selected person may be displayed to be emphasized. For example, as shown in FIG. 16, in a case where the desk icon I2 is pressed in a state in which “iijk” who is the user in “aa building 2F” is selected from the list of the destinations displayed as a list in the registered destination list screen G1, the seat table screen G2 of aa building 2F is initially displayed. At this time, as shown in FIG. 17, the seat table screen G2 may be displayed so as to indicate the seat of the selected person (in the example shown in FIG. 17, a check mark is provided to the seat G22 of the selected person).

As described above, whether the destination to send the email is correct or not can be finally confirmed more clearly by the display controller causing the display 151 to emphasize the seat of the selected person when initially displaying the seat table including the person who was selected in the registered destination list screen. Thus, it is possible to specify the destination more accurately.

### Modification Example 10

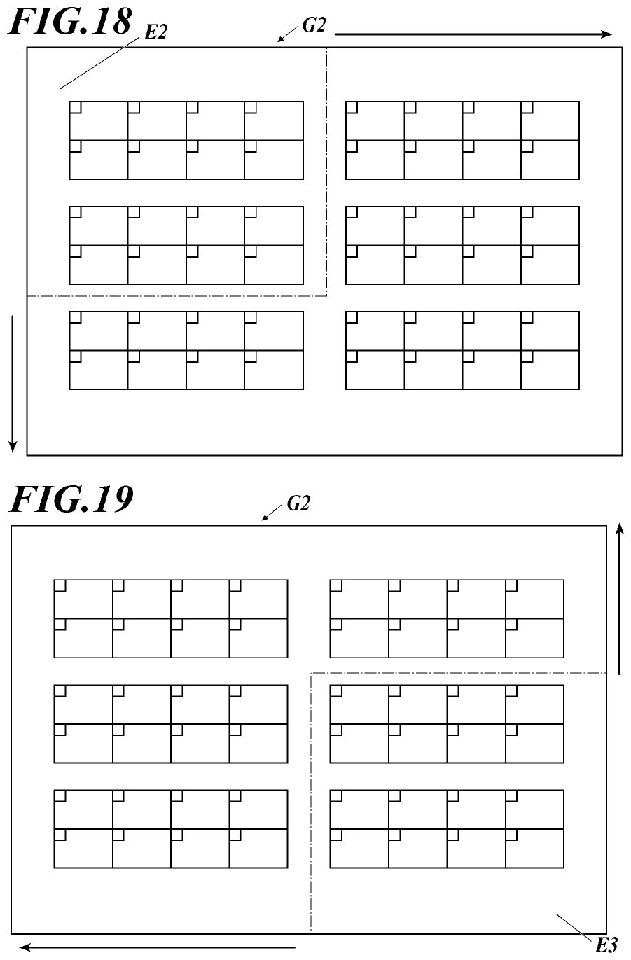

There can be a case where the entire seat table to be displayed cannot be displayed within the display 151 (cannot be completely displayed) when the seat table is displayed on the display 151. In such a case, as shown in FIG. 18, the seat table may be displayed to be scrollable in the vertical direction and the horizontal direction from the initially displayed portion E2 (portion in the dotted line of FIG. 18).

As described above, the entire seat table can be displayed even in a case where the entire seat table cannot be displayed within the display 151, by the display controller displaying the seat table to be scrollable in a case where the entire seat table cannot be displayed in the display 151. Thus, it is possible to surely find out the destinations.

### Modification Example 11

When the seat table is displayed to be scrollable (i.e., scrollable), the area E3 (area in the dotted line in FIG. 18) including the seat of the user may be initially displayed as shown in FIG. 19. The coordinates of the area E3 to be initially displayed on the display 151 are determined by referring to “desk coordinates D17” of the user in the seat table D1 (see FIG. 4).

As described above, the area including seats around the seat of the user to which the email is most likely to be sent is initially displayed by the display controller causing the display 151 to initially display the area including the seat of the user when the seat table is displayed to be scrollable. Thus, it is possible to improve the operation efficiency of the image forming device 10 regarding specification of the destinations.

### Modification Example 12

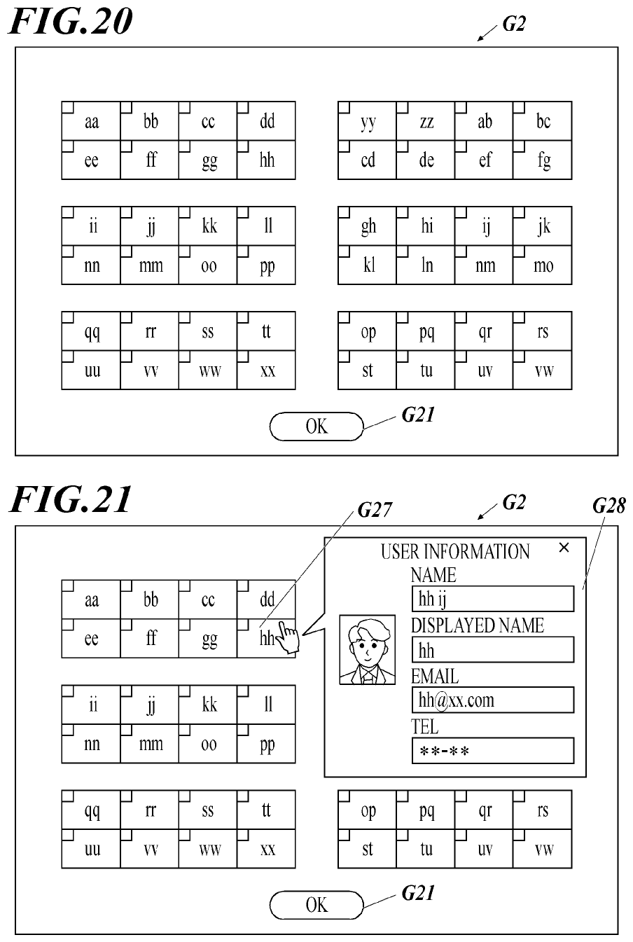

When the seat table is displayed on the display 151, the name of the person corresponding to each seat may be displayed as shown in FIG. 20. The name of the person displayed for each seat is obtained by referring to “displayed name D12” in the seat table D1 (see FIG. 4).

As described above, the person corresponding to the seat can be recognized accurately by the display controller displaying the name of the person corresponding to each seat when the seat table is displayed on the display 151. Thus, it is possible to specify the destinations accurately.

### Modification Example 13

As shown in FIG. 21, in a case where the seat G27 for which the name of the person corresponding to the seat is displayed is selected, the personal information G28 of the person of the selected seat G27 may be displayed. For example, the personal information G28 is property information such as the face photograph, name, email address and the phone number of the person corresponding to the seat and the section to which the person belongs. The personal information G28 to be displayed is obtained by referring to each piece of information of the seat table D1 (see FIG. 4).

As descried above, the person corresponding to the seat can be recognized more accurately by the display controller causing the display 151 to display the personal information of the person of the selected seat in a case where the seat, for which the name of the person corresponding to the seat is displayed, is selected. Thus, it is possible to specify the destinations more accurately.

### Modification Example 14

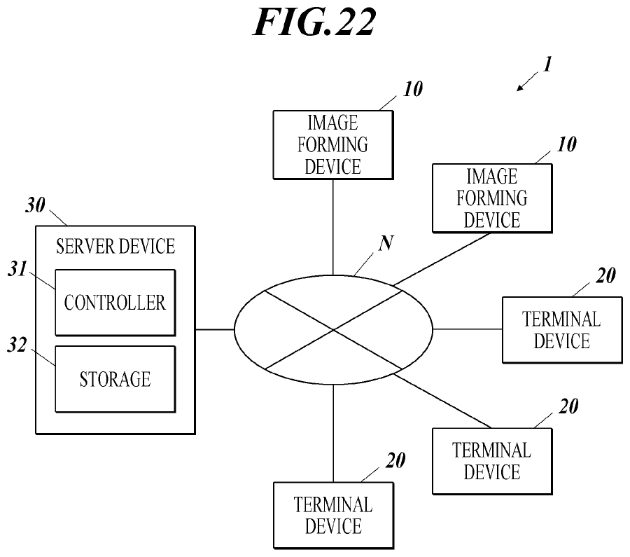

Though the data of the seat table is stored in the storage 14 in the image forming device 10 in one or more embodiments, the present invention is not limited to this. For example, as shown in FIG. 22, the image forming system 1 may be configured by including the image forming device 10, the terminal device 20, and a server device (information processing device) 30, and the data of the seat table may be stored in a storage 32 in the server device 30. The server device 30 is configured by including at least a controller (hardware processor) 31 and the storage 32. The storage 32 stores user information (for example, email address) of all the persons included in the seat table together with the data of the seat table.

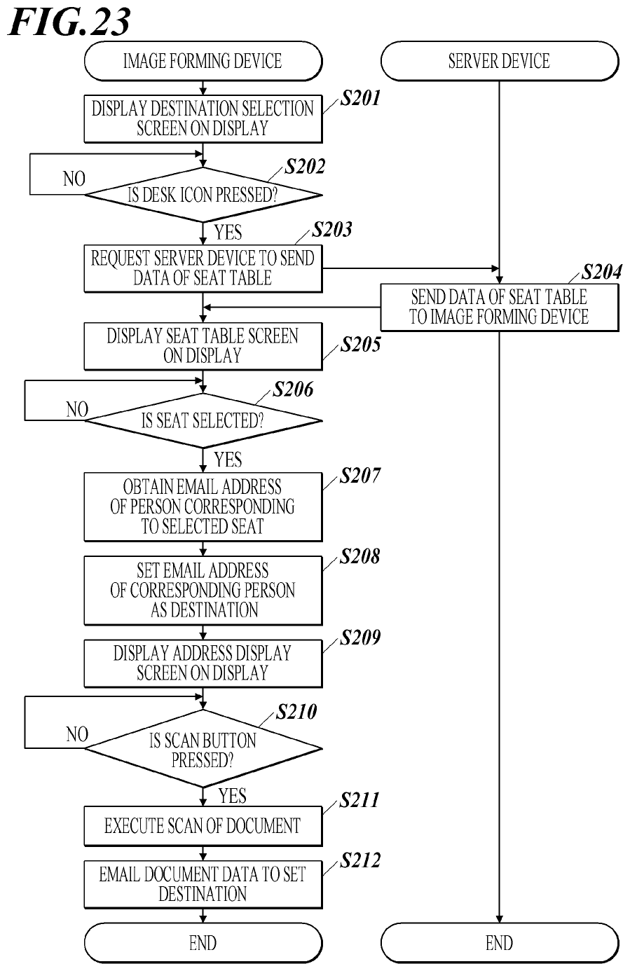

Hereinafter, the operation of the image forming system 1 in the modification example 14 will be described with reference to the flowchart in FIG. 23.

Since the processing of steps S201 and S202 is similar to the processing of steps S101 and S102 in FIG. 5, the explanation thereof is omitted.

The controller 11 requests the server device 30 to send the data of the seat table (step S203).

Next, the controller 31 of the server device 30 reads out the data of the seat table stored in the storage 32, and sends the read data to the image forming device 10 (step S204). That is, the controller 31 functions as a seat table sender of one or more embodiments of the present invention. At this time, the user information (email address) of all the persons included in the seat table is sent together with the data of the seat table.

The controller 11 of the image forming device 10 causes the display 151 to display the seat table screen G2 (see FIG. 7) on the basis of the data of the seat table sent from the server device 30 in step S204 (step S205).

Since the processing of steps S206 to S212 is similar to the processing of step S104 to S110 in FIG. 5, the explanation thereof is omitted.

As described above, the information processing device (server device 30) of the image forming system 1 in the modification example 14 includes a storage 32 which stores the seat table in which the seat position of each person and the email address of the person are associated with each other, and a seat table sender (controller 31) which sends the seat table stored in the storage 32 to the image forming device 10. The image forming device 10 includes an image reader 12 which reads an image of the document, an email sender 18 which sends the email with the attached document data obtained by the image reader 12 reading the image of the document, a display controller (controller 11) which causes the display 151 to display the seat table which was sent by the seat table sender, and a destination setter (controller 11) which sets, as the destination to send the email by the email sender 18, the email address of the person corresponding to the seat which was selected by the user from the seat table that is displayed on the display 151 by the display controller.

Thus, according to the image forming system 1 in the modification example 14, it is not necessary to remember the email address or full name of the addressee since the destination to send the email can be specified by seeing the seat table displayed on the display 151. Thus, it is possible to specify the destination easily and accurately. Furthermore, since the seat table can be stored in the storage 32 of the server device 30 different from the image forming device 10, it is possible to display the seat table even if the storage capacity of the storage 14 in the image forming device 10 is small.

In the modification example 14, the user information (email address) of all the persons included in the seat table is sent together with the data of the seat table in step S204. However, the present invention is not limited to this. For example, only the data of the seat table may be sent in step S204. When the seat is selected in step S206, the user may request the server device 30 to send the user information (email address) of the person corresponding to the selected seat. In this case, the controller 31 of the server device 30 reads out the user information (email address) of the person corresponding to the seat from the storage 32 and sends the read user information to the image forming device 10. The controller 11 of the image forming device 10 obtains the user information (email address) which was sent from the server device 30 (step S207).

In the modification example 14, the explanation is made by illustrating the configuration in which data of the seat table and the user information of all the persons included in the sear table are stored in the storage 32 of the server device 30. However, the present invention is not limited to this. For example, the data of the seat table may be stored in the storage 14 of the image forming device 10, and the user information of all the persons included in the seat table may be stored in the storage 32 of the server device 30. Alternatively, the data of the seat table may be stored in the storage 32 of the server device 30, and the user information of all the persons included in the seat table may be stored in the storage 14 of the image forming device 10.

### Other Modification Example

In one or more embodiments, the seat table screen G2 is displayed when the desk icon I2 is pressed after the registered destination list screen G1 is displayed on the display 151. However, the present invention is not limited to this. For example, by providing a button or an icon for displaying the seat table screen G2 in the menu screen, it is possible to display the seat table screen G2 not via the registered destination list screen G1.

As for the other detailed configurations and the detailed operations of devices forming the image forming system, modifications can be made as needed within the scope of the present invention.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image forming device, comprising:
an image former that forms an image on a sheet;
an image reader that reads an image of a document; and
a hardware processor that:
sends an email with attached document data that is obtained using the image reader;
causes a display to display a seat table in which a seat position of a person is associated with an email address of the person; and
sets, as a destination of the email, an email address of a person that corresponds to a seat that is selected by a user from the seat table.

2. The image forming device according to claim 1, wherein the hardware processor further sets, as destinations of the email, email addresses of people that correspond to seats selected by the user.

3. The image forming device according to claim 2, wherein the hardware processor further sets, as the destinations of the email, the email addresses of people that correspond to seats that are selected by the user at once with a block unit.

4. The image forming device according to claim 2, wherein the hardware processor further sets, as the destinations of the email, the email addresses of people that correspond to seats in a region on the display specified by the user.

5. The image forming device according to claim 2, wherein
the hardware processor further:
causes the display to display the seat table in which seat positions of people are associated with a group that the people belong to, and
sets, as the destinations of the email, the email addresses of people that correspond to seats selected by the user at a same time by selecting the group.

6. The image forming device according to claim 1, wherein
the hardware processor further:
causes the display to display a registered destination list screen that includes a list of destinations that are registered in advance, and
causes the display to display the seat table based on a predetermined user operation in the registered destination list screen.

7. The image forming device according to claim 1, wherein the hardware processor further causes the display to display the seat table for each of a building and a floor.

8. The image forming device according to claim 7, wherein the hardware processor further causes the display to first display the seat table of the building and the floor where the image forming device is disposed.

9. The image forming device according to claim 7, wherein the hardware processor further causes the display to first display the seat table that includes a seat of the user.

10. The image forming device according to claim 7, wherein the hardware processor further causes the display to first display the seat table that includes a person selected from a registered destination list screen that displays a list of destinations that are registered in advance.

11. The image forming device according to claim 10, wherein when the display displays the seat table that includes the person selected in the registered destination list screen:
the hardware processor further causes the display to display a seat of the person selected in the registered destination list screen, and
the seat is emphasized on the display.

12. The image forming device according to claim 1, wherein the seat table is scrollable when an entirety of the seat table is not displayed on the display.

13. The image forming device according to claim 12, wherein the hardware processor further causes the display to first display an area of the seat table that includes a seat of the user when the seat table is scrollable.

14. The image forming device according to claim 1, further comprising a storage that stores the seat table.

15. The image forming device according to claim 1, wherein when the seat table is displayed, the hardware processor further causes the display to display a name that corresponds to each seat in the seat table.

16. The image forming device according to claim 15, wherein the hardware processor further causes the display to display personal information of a person that corresponds to a selected seat.

17. An image forming system comprising:
an image forming device that includes:
an image former that forms an image on a sheet; and
a first hardware processor; and
an information processing device that is connected to the image forming device to communicate data with the image forming device, wherein
the information processing device includes:
a storage that stores a seat table in which a seat position of a person is associated with an email address of the person; and
a second hardware processor that sends the seat table the image forming device,
the image forming device further includes:
an image reader that reads an image of a document, wherein
the first hardware processor:
sends an email with attached document data obtained by the image reader,
causes a display to display the seat table, and
sets, as a destination of the email, an email address of a person that corresponds to a seat that is selected by a user from the seat table.

18. A destination setting method of an image forming device that includes an image former that forms an image on a sheet and an image reader, the method comprising:
displaying a seat table in which a seat position of a person is associated with an email address of the person; and
setting, as a destination of an email, an email address of a person that corresponds to a seat selected by a user from the seat table, wherein the email is sent with an attached document data obtained by the image reader.
